(19) United States
(12) Patent Application Publication
(10) Pub. No.: US 2022/0207351 A1
(43) Pub. Date: Jun. 30, 2022

(54) SEMICONDUCTOR DESIGN OPTIMIZATION USING AT LEAST ONE NEURAL NETWORK

(71) Applicant: SEMICONDUCTOR COMPONENTS INDUSTRIES, LLC, Phoenix, AZ (US)

(72) Inventors: Tirthajyoti SARKAR, Fremont, CA (US); Diann M. DOW, Austin, TX (US); Gary Horst LOECHELT, Tempe, AZ (US); Prateek SHARMA, Austin, TX (US)

(73) Assignee: SEMICONDUCTOR COMPONENTS INDUSTRIES, LLC, Phoenix, AZ (US)

(21) Appl. No.: 17/137,773

(22) Filed: Dec. 30, 2020

(51) Int. Cl. G06N 3/08; G06F 30/31; G06F 30/367; G06N 3/04

(52) U.S. Cl. CPC G06N 3/08; G06N 3/0454; G06F 30/367; G06F 30/31

(57) ABSTRACT

According to an aspect, a semiconductor design system includes at least one neural network including a first predictive model and a second predictive model, where the first predictive model is configured to predict a first characteristic of a semiconductor device, and the second predictive model is configured to predict a second characteristic of the semiconductor device. The semiconductor design system includes an optimizer configured to use the neural network to generate a design model based on a set of input parameters, where the design model includes a set of design parameters for the semiconductor device such that the first characteristic and the second characteristic achieve respective threshold conditions.

### FIELD OF THE DISCLOSURE

The present disclosure relates to semiconductor design optimization using at least one neural network.

### BACKGROUND

Technology computer-aided design (TCAD) simulations can be used to model semiconductor fabrication and semiconductor device operations. However, TCAD simulations are generally based on finite-element solver dynamics, which can be computationally prohibitive, particularly when involving a large-scale optimization goal such as multi-scale, mixed-mode optimization. Additionally, predicting control settings for a large-scale optimization goal using TCAD simulations may involve executing multiple TCAD models simultaneously and capturing the circuit-level dynamics through optimizing fabrication process inputs, which may lead to instability and increased computational complexity.

### SUMMARY

According to an aspect, a semiconductor design system includes at least one neural network including a first predictive model and a second predictive model, where the first predictive model is configured to predict a first characteristic of a semiconductor device, and the second predictive model is configured to predict a second characteristic of the semiconductor device. The semiconductor design system includes an optimizer configured to use the neural network to generate a design model based on a set of input parameters, where the design model includes a set of design parameters for the semiconductor device such that the first characteristic and the second characteristic achieve respective threshold conditions.

According to some aspects, the semiconductor design system may include one or more of the following features (or any combination thereof). Each of the first characteristic and the second characteristic may include breakdown voltage, specific on-resistance, voltage threshold, or efficiency. The set of design parameters may include at least one of process parameters, circuit parameters, or device parameters. The design model may include a visual object that graphically represents a fabrication process for creating the semiconductor device. The semiconductor design system may include a plurality of data sources including a first data source and a second data source, where the first data source includes first simulation data about process variables of the semiconductor device, and the second data source includes second simulation data about circuit variables of the semiconductor device. The semiconductor design system may include a trainer module configured to train the neural network based on data received from the first data source and the second data source. The trainer module may include a data filter configured to filter the data from the first data source and the second data source to obtain a dataset of filtered data, and a data identifier configured to identify training data and test data from the dataset, where the training data is configured to be used to train the neural network, and the test data is configured to be used to test an accuracy of the neural network. The trainer module may include a testing engine configured to test the accuracy of the neural network based on the test data. The testing engine is configured to generate at least one quality check graph that depict predicted values for the first characteristic in view of ground truth values for the first characteristic. The data filter may include a data type module configured to identify that tabular data from the plurality of data sources is associated with the first data source, a logic rule selector configured to select a set of logic rules from a domain knowledge database that corresponds to the first data source, and a logic rule applier configured to apply the set of logic rules to the tabular data to remove one or more missing values within a row or column or remove one or more values that are not varying within a row or column. The at least one neural network may include a first neural network and a second neural network, where the first neural network is configured to be trained using first parameters to predict second parameters, and the second neural network is configured to be trained using the second parameters to predict system level parameters for the semiconductor device. The first parameters may include first simulation data about process variables of the semiconductor device, and the second parameters may include second simulation data about circuit variables of the semiconductor device.

According to an aspect, a non-transitory computer-readable medium storing executable instructions that when executed by at least one processor is configured to cause the at least one processor to receive, by an optimizer, a set of input parameters for designing a semiconductor device, initiate, by the optimizer, at least one neural network to execute a first predictive model and a second predictive model, where the first predictive model is configured to predict a first characteristic of a semiconductor device based on the input parameters and the second predictive model is configured to predict a second characteristic of the semiconductor device based on the input parameters, and generate, by the optimizer, a set of design parameters for the semiconductor device such that the first characteristic and the second characteristic achieve respective threshold conditions.

According to some aspects, the non-transitory computer-readable medium may include one or more of the above/below features (or any combination thereof). The executable instructions include instructions that cause the at least one processor to initiate, by the optimizer, the at least one neural network to execute a third predictive model and a fourth predictive model, where the third predictive model is configured to predict a third characteristic of the semiconductor device based on the input parameters and the fourth predictive model is configured to predict a fourth characteristic of the semiconductor device based on the input parameters. The set of design parameters are generated such that the first characteristic, the second characteristic, the third characteristic, and/or the fourth characteristic are maximized or minimized. The executable instructions include instructions that cause the at least one processor to receive data from a plurality of data sources, filter the data based on a domain knowledge database to obtain a dataset of filtered data, and randomly split the dataset into training data and test data, where the training data is configured to be used to train the neural network and the test data is used to test the neural network. The plurality of data sources include a first data source that includes technology computer-aided design (TCAD) simulation variables, a second data source that includes simulation program with integrated circuit emphasis (SPICE) simulation variables, a third data source that includes power electronics lab results, and a fourth data source that includes wafer level measurements. The executable instructions to filter the data include instructions that cause the at least one processor to identify that data is associated with a first data source among the plurality of data sources, select a set of logic rules from the domain knowledge database that corresponds to the first data source, and apply the set of logic rules to the data to filter the data. The at least one neural network may include a first neural network and a second neural network, where the first neural network is configured to be trained using first parameters to predict second parameters, and the second neural network is configured to be trained using the second parameters to predict system level parameters for the semiconductor device. The first parameters includes technology computer-aided design (TCAD) simulation variables. The second parameters includes simulation program with integrated circuit emphasis (SPICE) simulation variables.

According to an aspect, a method for semiconductor design system includes receiving data from a plurality of data sources including a first data source and a second data source, where the first data source includes first simulation data about process variables of a semiconductor device and the second data source includes second simulation data about circuit variables of the semiconductor device, filtering the data based on at least one set of logic rules from a domain knowledge database to obtain a dataset of filtered data, identifying training data and test data from the dataset, where the training data is used to train at least one neural network and the test data is used to test an accuracy of the at least one neural network, receiving a set of input parameters for designing a semiconductor device, executing, by the at least one neural network, a first predictive model and a second predictive model, where the first predictive model is configured to predict a first characteristic of a semiconductor device based on the input parameters and the second predictive model is configured to predict a second characteristic of the semiconductor device based on the input parameters, and generating a set of design parameters for a design model of the semiconductor device such that the first characteristic and the second characteristic achieve respective threshold conditions.

According to some aspects, the method may include one or more of the above/below features (or any combination thereof). The plurality of data sources include a third data source and a fourth data source, where the third data source includes power electronics lab results and the fourth data source includes wafer level measurements. The filtering step may include identifying that first data is associated with the first data source, selecting a first set of logic rules from the domain knowledge database that corresponds to the first data source, applying the first set of logic rules to the first data, identifying that second data is associated with the second data source, selecting a second set of logic rules from the domain knowledge database that corresponds to the second data source and applying the second set of logic rules to the second data. The at least one neural network may include a first neural network and a second neural network. The method may include training the first neural network using technology computer-aided design (TCAD) simulations to predict simulation program with integrated circuit emphasis (SPICE) variables and training the second neural network with the SPICE variables to predict system level parameters.

The foregoing illustrative summary, as well as other exemplary objectives and/or advantages of the disclosure, and the manner in which the same are accomplished, are further explained within the following detailed description and its accompanying drawings.

### BRIEF DESCRIPTION OF THE DRAWINGS

FIG. 1A illustrates a semiconductor design system having one or more neural networks according to an aspect.

FIG. 1B illustrates an example of a design model generated by the semiconductor design system according to an aspect.

FIG. 1C illustrates an example of a data filter of the semiconductor design system according to an aspect.

FIG. 1D illustrates a plurality of predictive models of the neural network of the semiconductor design system according to an aspect.

FIG. 1E illustrates an example of a fully connected neural network according to an aspect.

FIG. 1F illustrates an example of a partially connected neural network according to an aspect.

FIG. 2 illustrates a flowchart depicting example operations of a semiconductor design system according to an aspect.

FIGS. 3A and 3B illustrate flowcharts depicting example operations of a semiconductor design system according to another aspect.

FIG. 4 illustrates a semiconductor design system having multiple neural networks according to an aspect.

FIG. 5 illustrates a flowchart depicting example operations of a semiconductor design system.

FIG. 6 illustrates a representative plot of training error versus epochs according to an aspect.

FIGS. 7A and 7B illustrate graphs depicting predicted parameter values of test data applied to a neural network versus true parameter values according to an aspect.

### DETAILED DESCRIPTION

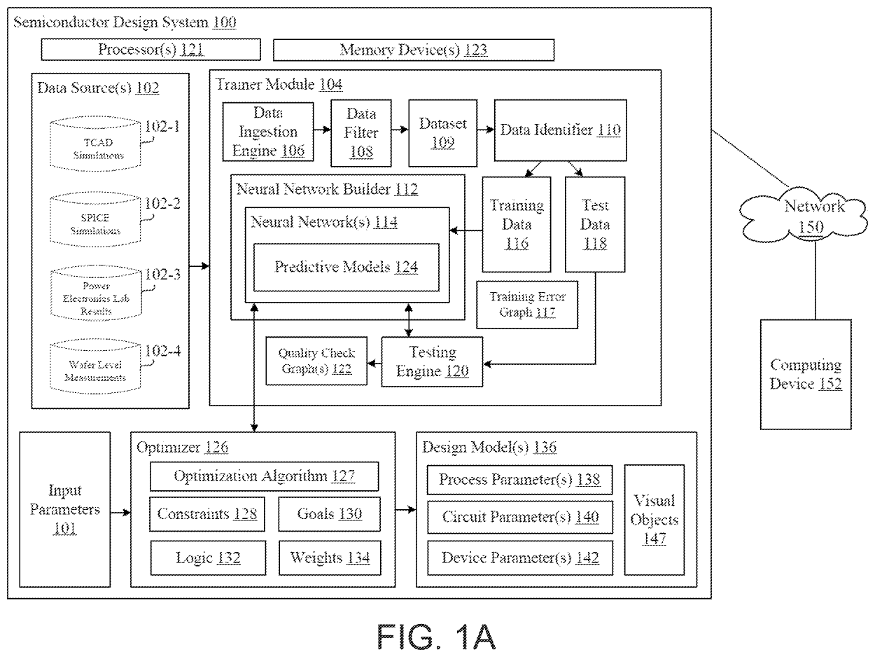

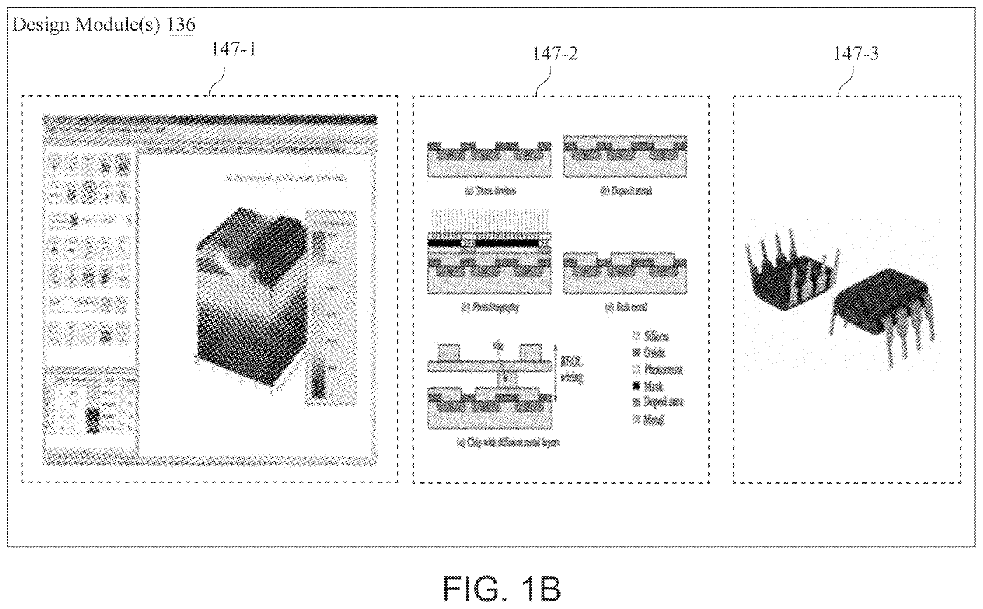

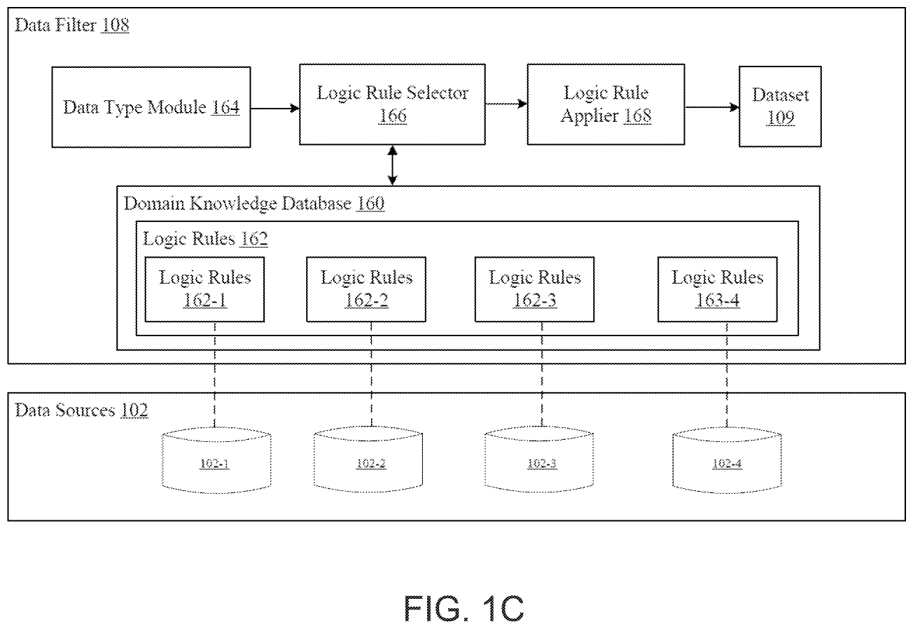

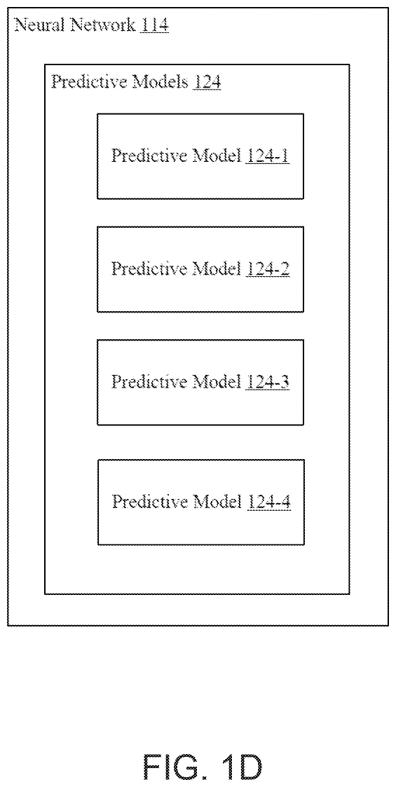

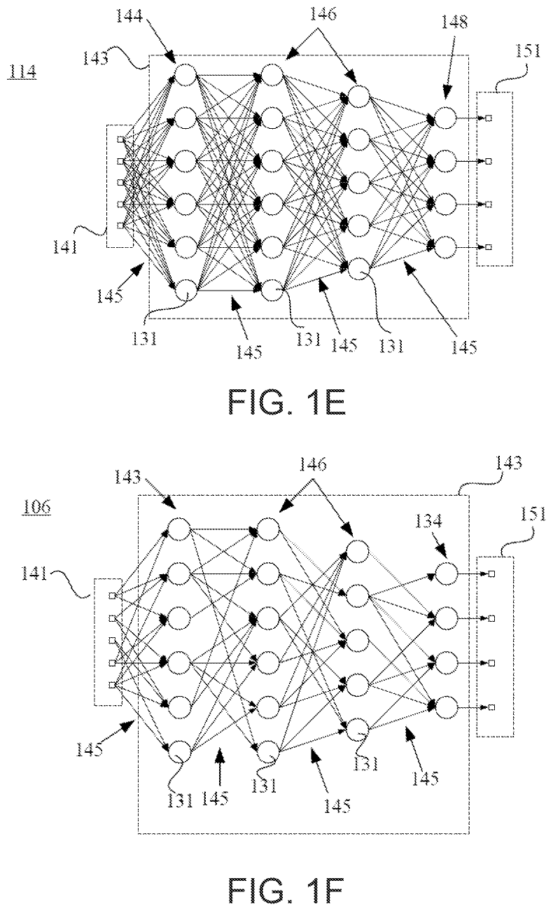

FIGS. 1A through 1F illustrate a semiconductor design system 100 for designing and optimizing a semiconductor device (e.g., transistor(s), circuit(s), and/or package) using one or more neural networks 114 according to an aspect. The semiconductor design system 100 may determine (e.g., optimize), using the neural network(s) 114, parameters for the transistor(s), the circuit(s) that include the transistor(s), and/or the fabrication process for manufacturing the semiconductor device/package in a manner that is relatively fast and accurate. For example, the semiconductor design system 100 may compute a design model 136 (or multiple design models 136) that includes process parameters 138, circuit parameters 140, and/or device parameters 142 such that the design model 136 achieves one or more performance metrics (also referred to as characteristics), which computed by the neural network(s) 114 and optimized by an optimizer 126.

The process parameters 138 may provide the control parameters for controlling the fabrication process such as parameters for providing (or creating) a silicon substrate (including the doped regions), parameters for placing one or more semiconductor devices, parameters for depositing one or more metal/semiconductor/dielectric layers (e.g., oxidization, photoresist, etc.), parameters and patterns for photolithography, parameters for etching one or more metal/semiconductor/dielectric layers, and/or parameters for wiring. The device parameters 142 may include packaging parameters such as wafer-level or package level parameters, including metal cutting and/or molding, geometry of various mask patterns, placement pattern of special conductive structures on the device for controlling switching dynamics, etc. The circuit parameters 140 may include parameters for the structure (e.g., connections, wiring) of a circuit and/or parameters for circuit elements as values for resistors, capacitors, and inductors, and parameters related to the size of active semiconductor devices, etc.

In addition, the design model 136 may include visual objects 147 (e.g., visualizations) that aid the designer at the process-level, device-level, circuit-level, and/or package-level. As shown in FIG. 1B, the design model 136 may include visual objects 147 that specify control parameters in the form of visualizations. For example, the visual objects 147 may include a visual object 147-1 that graphically illustrates parameters regarding a semiconductor device such as the thickness and the doping of impurities on a semiconductor inside an electric field, a visual object 147-2 that graphically illustrates parameters for fabrication operations for constructing a semiconductor device, and/or a visual object 147-3 that graphically illustrates parameters for packaging a semiconductor device such as metal cutting and/or molding.

In some examples, the semiconductor design system 100 is configured to enhance the speed of optimization for relatively large optimization problems (e.g., involving tens, hundreds, or thousands of variables) and/or for mixed mode optimization problems (e.g., optimization of semiconductor carrier dynamics within a circuit application, which may involve the solving of semiconductor equations along with circuit equations).

The semiconductor design system 100 constructs and trains a neural network 114 using data from one or more data sources 102. In some examples, the semiconductor design system 100 constructs and trains the neural network 114 using multiple data sources 102. Each data source 102 may represent a different testing or data-generating (e.g., simulating, measuring IC parameters in a lab) technology. In some examples, the neural network 114 is a unified model that can function across data derived from multiple data sources 102 involving multiple different testing technologies. The data sources 102 may include technology computer-aided design (TCAD) simulations, simulation program with integrated circuit emphasis (SPICE) simulations, power electronics lab results, and/or wafer/product level measurements. For example, one data source 102 may include the TCAD simulations (e.g., TCAD simulation variables) while another data source 102 may include the SPICE simulations (e.g., SPICE simulation variables) and so forth. However, the data sources 102 may include any type of data that simulates, measures, and/or describes the device, circuit, and/or process characteristics of a semiconductor device/system.

Generally, the semiconductor design system 100 obtains data from the data source(s) 102, filters the data using logic rules 162 from a domain knowledge database 160 to obtain a dataset 109 of filtered data, and identifies training data 116 and test data 118 from the dataset 109 (e.g., performs a random split of the dataset 109 into training data 116 and test data 118). The semiconductor design system 100 constructs a neural network 114 based on various configurable parameters (e.g., number of hidden layers, number of neurons in each layer, activation function, etc.), which can be supplied by a user of the semiconductor design system 100. The neural network 114 is then trained using the training data 116. The neural network 114 may include or define one or more predictive models 124, where each predictive model 124 corresponds to a different characteristic or performance metric (e.g., efficiency, breakdown voltage, threshold voltage, etc.). For example, a predictive model 124 relating to efficiency may predict the efficiency of the semiconductor system based on a given set of inputs. In some examples, the predictive models 124 are regression-based predictive functions. Then, the semiconductor design system 100 can apply the test data 118 to the neural network 114 and evaluate the performance of the neural network 114 by comparing the predictions to the true values of the test data 118. Based on the test results, the neural network 114 can be tuned.

The semiconductor design system 100 includes an optimizer 126 configured to operate in conjunction with the predictive model(s) 124 of the neural network 114 to generate the design model 136 in accordance with input parameters 101. In some examples, the optimizer 126 and the predictive models 124 operate in an optimization loop that is relatively fast and accurate as compared to some conventional techniques (e.g., such as TCAD simulations). In some examples, the neural network-based optimizer is faster (e.g., significantly faster) than a single physical-based TCAD simulation. For example, the optimizer 126 (in conjunction with the predictive model(s) 124) may determine the process parameters 138, circuit parameters 140 and/or device parameters 142 such that characteristics (e.g., efficiency, breakdown voltage, threshold voltage, etc.) of the predictive model(s) 124 achieve a threshold result (e.g., maximized, minimized) while meeting constraints 128 and/or goals 130 of the optimizer 126.

The use of the neural network 114 within the optimizer 126 can increase (e.g., greatly increase) the speed of optimization. For example, conventional TCAD-based systems may model the device and process characteristics by solving complex (nonlinear) differential equations, which may be computational expensive and time consuming. TCAD uses nonlinear differential equations to describe semiconductor-related physics (e.g., motion of electron holes, internal charge carriers inside the semiconductor) to simulate the behavior of a semiconductor device. In some examples, TCAD uses nonlinear differential equations to describe the semiconductor-related physics and electromagnetic-related and thermal-related physics to simulate the behavior of a system involving a semiconductor device, a circuit, and/or a semiconductor package. However, simulating the behavior of a semiconductor device within a circuit using TCAD is computationally expensive and may involve a relatively long time to obtain different variations. According to the embodiments discussed herein, TCAD simulations may be used to train the neural network 114 (at least in part). However, in some examples, during optimization, the semiconductor design system 100 may not use TCAD simulations in generating the actual design model 136, which can increase the speed of optimization.

Further, the semiconductor design system 100 may execute multi-scale, mixed mode optimization for semiconductor design in a manner that is relatively fast and accurate. For example, mixed mode optimization may involve a semiconductor device and a power circuit (or another type of circuit). Optimization involving multiple modes (e.g., a semiconductor device and a circuit having the semiconductor device) may involve the solving of equations using different physics (e.g., semiconductor physics, thermal physics, and/or circuit physics), which includes multiple scales of time and/or space. As such, multi-scale, mixed mode optimization may be computationally expensive using conventional approaches such as TCAD and/or SPICE simulations. Furthermore, convergence may be an issue in multi-scale, mixed mode optimization (e.g., where data values do not converge to a particular value). However, the semiconductor design system 100 may perform multi-scale, mixed mode optimization using the neural network 114 in a relatively fast and accurate manner that reduces the amount of times that convergence does not occur.

The semiconductor design system 100 includes one or more processors 121, which may be formed in a substrate configured to execute one or more machine executable instructions or pieces of software, firmware, or a combination thereof. The processors 121 can be semiconductor-based—that is, the processors can include semiconductor material that can perform digital logic. The semiconductor design system 100 can also include one or more memory devices 123. The memory devices 123 may include any type of storage device that stores information in a format that can be read and/or executed by the processor(s) 121. The memory devices 123 may store executable instructions that when executed by the processor(s) 121 are configured to perform the functions discussed herein.

In some examples, one or more of the components of the semiconductor design system 100 is stored at a server computer. For example, the semiconductor design system 100 may communicate with a computing device 152 over a network 150. The server computer may be computing devices that take the form of a number of different devices, for example a standard server, a group of such servers, or a rack server system. In some examples, the server computer is a single system sharing components such as processors and memories. The network 150 may include the Internet and/or other types of data networks, such as a local area network (LAN), a wide area network (WAN), a cellular network, satellite network, or other types of data networks. The network 150 may also include any number of computing devices (e.g., computer, servers, routers, network switches, etc.) that are configured to receive and/or transmit data within network 150. In some examples, a designer may use the computing device 152 to supply the user inputs (e.g., building stage of the neural network(s) 114, neural network training, neural network tuning, one or more input parameters 101, etc.), which are received at the semiconductor design system 100 over the network 150. The computing device 152 may provide the results (e.g., quality check graph(s) 122, design model(s) 136, training error graph 117, etc.) of the simulation and/or training process.

The semiconductor design system 100 may be used to assist with designing and optimizing a semiconductor device. The semiconductor device may include one or more switches (e.g., transistors, field-effect transistors (FETs), metal-oxide-semiconductor field effect transistors (MOSFETs). In some examples, the semiconductor device is a power converter such as a buck converter, switching resonant converter, boost converter, inverting buck-boost converter, fly-back converter, active clamp forward converter, single switch forward converter, two switch forward converter, push-pull converter, half-bridge converter, full-bridge converter, phase-shifted full-bridge converter, etc. In some examples, the semiconductor device includes one or more circuit components such as diodes, capacitors, inductors, and/or transformers, etc.

The data sources 102 are used to train and test the neural network 114. The data sources 102 may include a first data source 102-1 that includes simulation results (e.g., TCAD simulations) of a semiconductor design application (e.g., a TCAD simulator) that can model device, circuit, and fabrication process characteristics of integrated circuits, a second data source 102-2 that includes simulation results (e.g., SPICE simulations) of an electronic circuit simulator (e.g., a SPICE simulator) that can simulate circuit characteristics of integrated circuits, a third data source 103-3 that includes results of a power electronic lab that can obtain the device characteristics of integrated circuits, and/or a fourth database 102-4 that includes wafer/product level measurements (e.g., derived from a wafer probe) about semiconductor devices and/or packaged product. Although four data sources 102 are illustrated in FIG. 1A, the semiconductor design system 100 may include a single data source 102 or multiple data sources 102 such as any number of data sources 102 greater or equal to two.

The semiconductor design system 100 includes a trainer module 104 configured to train and test the neural network 114 based on the data included in the data source(s) 102. For example, the trainer module 104 includes a data ingestion engine 106 that communicates and receives data from the data source(s) 102, a data filter 108 that filters and/or formats the data to obtain a dataset 109, a data identifier 110 that identifies training data 116 and test data 118 from the dataset 109, a neural network builder 112 that constructs a neural network 114 defining one or more predictive models 124, and a testing engine 120 that evaluates the neural network 114 for accuracy and generates one or more quality check graphs 122.

The data ingestion engine 106 may communicate with the data source(s) 102 to obtain the data within the data source(s) 102. In some examples, the data source(s) 102 are located remote from the trainer module 104, and the data ingestion engine 106 may receive the data within the data source(s) 102 over the network 150. In some examples, the data obtained from the data source(s) 102 is tabular data, e.g., data arranged in a table with columns and rows. The data filter 108 may receive and filter the data to obtain a dataset 109, which may include removing data that is not varying (e.g., not of particular interest) within a particular row or column, discarding missing values within a particular row or column, and/or inserting values for data that is missing. In some examples, the data ingestion engine 106 receives the data from one data source 102 at a time. For example, the data ingestion engine 106 may receive the data from the first data source 102-1 and the data filter 108 may filter the data from the first data source 102-1. Then, the data ingestion engine 106 may receive the data from the second data source 102-2 and the data filter 108 may filter the data from the second data source 102-1. This process may continue for all the data sources 102-4, where the dataset 109 may represent the filtered data across all the data sources 102.

The details of the data filter 108 are explained with reference to FIG. 1C. The data filter 108 may include a data type module 164, a logic rule selector 166, a logic rule applier 168, and a domain knowledge database 160. The domain knowledge database 160 may store a plurality of logic rules 162 that are used to filter/format the data within the data sources 102. For example, the plurality of logic rules 162 captures domain knowledge about the data sources 102 in the form of filtering/formatting logic that is used to filter and/or format data to place the data in a format that can operate within the neural network 114. In some examples, the plurality of logic rules 162 include a separate set of logic rules that is associated with a respective data source 102. Each data source 102 may include results from a different type of testing technology, and each of these results may need to be filtered/formatted differently.

The plurality of logic rules 162 may include logic rules 162-1 associated with the first data source 102-1, logic rules 162-2 associated with the second data source 102-2, logic rules 162-3 associated with the third data source 103-3, and logic rules 162-4 associated with the fourth data source 102-4. For example, the logic rules 162-1 may be applied to the TCAD simulations, the logic rules 162-2 may be applied to the PSPICE simulations, the logic results 162-3 may be applied to the power electronics lab results, and the logic results 162-4 may be applied to the wafer/product level measurements.

The data type module 164 may receive data from the data sources 102 and determine the type or source of the data. For example, the data type module 164 may analyze the data to determine whether the data corresponds to the first data source 102-1, the second data source 102-2, the third data source 102-3 and/or the fourth data source 102-4. The logic rule selector 166 may select the appropriate set of logic rules 162 that correspond to the source of the data. For example, if the data type module 164 determines that the data is associated with the first data source 102-1, the logic rule selector 166 may select the logic rules 162-1. If the data type module 164 determines that the data is associated with the second data source 102-2, the logic rule selector 166 may select the logic rules 162-2. The logic rule applier 168 may apply the logic rules 162 to the data that have been selected by the logic rule selector 166. For example, if the logic rules 162-1 have been selected, the logic rule applier 168 may apply the logic 162-1 to the data.

Although four sets of logic rules are illustrated, the embodiments encompass any number of sets of logic rules, which may be dependent on the number and inter-relationships of the data sources 102. The logic rules 162 may specify to discard data that is not varying (e.g., data that is unchanging). In some examples, the logic rules 162 may specify to discard static columns (e.g., where the data is not varying, and, therefore, not of particular interest). The logic rules 162 may specify to discard missing values. For example, values for one or more parameters may be missing, which may be caused by convergence errors. In some examples, the logic rules 162 may specify to add values when data values are missing. In some examples, the logic rules 162 may take an average of neighboring values and provide the averaged value for a missing value. In some examples, a logic rule 162 works specifically on wafer level measurement, such as filtering out outlier data points which fall outside a user-specified limit or dynamically calculated limits from the statistical distributions of the data (e.g., the data (e.g., all of the data) beyond four sigma for a Normal distribution). In other examples, a logic rule 162 works specifically on PSPICE simulations or lab measurements of circuits, such as discarding negative values of voltages on specific circuit nodes, which denote noise and not the expected outcome.

Referring back to FIG. 1A, the data identifier 110 is configured to receive the dataset 109 from the data filter 108 and identify training data 116 and test data 118 from the dataset 109. In some examples, the data identifier 110 is configured to randomly split the dataset 109 into training data 116 and test data 118. The training data 116 is used to train the neural network 114. The test data 118 is used to test the neural network 114. In some other embodiments, one training dataset and multiple small test datasets can be identified, based on multiple random splits. In this case, the trained neural network 114 is tested on multiple small test datasets to check the consistency of the training process and to ‘average-out’ any bias in the training data selection.

The neural network builder 112 is configured to construct the neural network 114. For example, the neural network builder 112 may receive user input for a number of configurable parameters such as the number of hidden layers 146 (as shown in FIG. 1E or 1F), the number of neurons 131 in each layer 143 (as shown in FIG. 1E or 1F), the type of activation function, etc. In some examples, the user may use the computing device 152 to identify the number of hidden layers 146, the number of neurons 131 in each layer 143, and the type of activation function. These configurable parameters may be transmitted over the network 150 to the semiconductor design system 100.

The neural network 114 may define one or more predictive models 124. In some examples, the user may use the computing device 152 to define the number and type of predictive models 124 for the neural network 114. In some examples, the neural network 114 may define a single predictive model 124. In some examples, the neural network 114 may define multiple neural networks 114. Each predictive model 124 may be trained to predict a separate characteristic (or performance metric). In one example, the characteristic is breakdown voltage of a transistor. However, the characteristic that is predicted by a predictive model 124 may encompass a wide variety of characteristics such as on-resistance, threshold voltage, efficiency (e.g., overall efficiency, individual efficiency of a particular stage or component), circuit operation metrics such as waveform quality or electromagnetic emission signature, various type of device capacitances and impedances, package parasitics and thermal impedance properties, and reliability metrics such as failure current under stress, etc. As further discussed below, a predictive model 124 is trained to accurately predict the breakdown voltage of a transistor across number of variables, and during optimization, the breakdown voltage is optimized (e.g., achieves a threshold such as minimized, maximized, exceeds a threshold level, or is below a threshold level) along with other characteristics of the other predictive models 124.

In some examples, as shown with respect to FIG. 1D, the predictive models 124 may include a first predictive model 124-1, a second predictive model 124-2, a third predictive model 124-3, and a fourth predictive model 124-4. Although four predictive models 124 are illustrated in FIG. 1D, the embodiments encompass any number of predictive models 124 (e.g., a single predictive model or two or more predictive models 124). In some examples, the first predictive model 124-1 is configured to predict the breakdown voltage of a transistor (e.g., breakdown voltage of drain-to-source (BVds). In some examples, the second predictive model 124-2 is configured to predict a specific on-resistance (e.g., RSP). In some examples, the third predictive model 124-3 is configured to predict a threshold voltage (e.g., Vth) of a transistor. In some examples, the fourth predictive model 124-4 is configured to predict efficiency of a semiconductor system. In some examples, the efficiency is the overall efficiency of the semiconductor system.

During training, the neural network 114 is configured to receive the training data 116 as an input such that the predictive models 124 are trained to accurately predict their respective characteristics. In some examples, the neural network 114 is trained with a number of configurable parameters such as the number of epochs, the learning rate, and/or batch size, etc. In some examples, the trainer module 104 is configured to generate a training error graph 117 that depicts the training error (e.g., root-mean-square-error (RMSE)). In some examples, the training error graph 117 depicts the RMSE against the number of epochs and/or learning rates. In some examples, the trainer module 104 is configured to generate one or more summary reports, which may include details about the model architecture. In some examples, the trainer module 104 generates plan English statements about each layer of the neural network 114.

During testing, the testing engine 120 is configured to apply the test data 118 to the neural network 114 to compute the models' predictions for all the inputs in the test set. The testing engine 120 is configured to generate one or more quality check graphs 122 that can plot the test performance against the ground truth (e.g., the true values of the test set). In some examples, the user can use the quality check graphs 122 to modify/tune the neural network 114.

The neural network 114 may be a fully connected neural network or a partially connected neural network. FIG. 1E illustrates a portion of a neural network 114 that is fully connected according to an aspect. FIG. 1F illustrates a portion of a neural network 114 that is partially connected according to an aspect. In some examples, the portion of the neural network 114 illustrated in FIG. 1E or 1F relates to a particular predictive model 124 (e.g., a first predictive model 124-1). The full neural network 114 may include other portions (not shown in FIG. 1E or 1F) that relate to other predictive models 124.

The neural network 114 includes a set of computational processes for receiving a set of inputs 141 (e.g., input values) and generating one or more outputs 151 (e.g., output values). Although four outputs 151 are illustrated in FIGS. 1E and 1F, the number of outputs 151 may be one, two, three, or more than four. In some examples, the portion of the neural network 114 depicted in FIG. 1E or 1F generates a single output 151 (e.g., the breakdown voltage). Another portion of the neural network 114 (not shown in FIG. 1E or 1F) would have another set of inputs 141 that generate another output (e.g., efficiency), and yet another portion of the neural network 114 (not shown in FIG. 1E or 1F) would have another set of inputs 141 that generate another output (e.g., voltage threshold) and so forth.

The neural network 114 includes a plurality of layers 143, where each layer 143 includes a plurality of neurons 131. The plurality of layers 143 may include an input layer 144, one or more hidden layers 146, and an output layer 148. In some examples, each output of the output layer 148 represents a possible prediction. In some examples, the output of the output layer 148 with the highest value represents the value of the prediction.

In some examples, the neural network 114 is a deep neural network (DNN). For example, a deep neural network (DNN) may have two or more hidden layers 146 disposed between the input layer 144 and the output layer 148. In some examples, the number of hidden layers 146 is two. In some examples, the number of hidden layers 146 is three or any integer greater than three. Also, it is noted that the neural network 114 may be any type of artificial neural network (ANN) including a convolution neural network (CNN). The neurons 131 in one layer 143 are connected to the neurons 131 in another layer via synapses 145. For example, each arrow in FIG. 1E or 1F may represent a separate synapse 145. Fully connected layers 143 (such as shown in FIG. 1E) connect every neuron 131 in one layer 143 to every neuron 131 in the adjacent layer 143 via the synapses 145.

Each synapse 145 is associated with a weight. A weight is a parameter within the neural network 114 that transforms input data within the hidden layers 146. As an input enters the neuron 131, the input is multiplied by a weight value and the resulting output is either observed or passed to the next layer in the neural network 114. For example, each neuron 131 has a value corresponding to the neuron's activity (e.g., activation value). The activation value can be, for example, a value between 0 and 1 or a value between −1 and +1. The value for each neuron 131 is determined by the collection of synapses 145 that couple each neuron 131 to other neurons 131 in a previous layer 143. The value for a given neuron 131 is related to an accumulated, weighted sum of all neurons 131 in a previous layer 143. In other words, the value of each neuron 131 in a first layer 143 is multiplied by a corresponding weight and these values are summed together to compute the activation value of a neuron 131 in a second layer 143. Additionally, a bias may be added to the sum to adjust an overall activity of a neuron 131. Further, the sum including the bias may be applied to an activation function, which maps the sum to a range (e.g., zero to 1). Possible activation functions may include (but are not limited to) rectified linear unit (ReLu), sigmoid, or hyperbolic tangent (Tan H). In some examples, the Sigmoid activation function, which is generally used for classification tasks, can be used for regression models (e.g., the predictive models 124) which may predict efficiency of a circuit. The use of the Sigmoid activation function may increase the speed and efficiency of the training process.

Referring back to FIG. 1A, the predictive models 124 of the trained neural network 114 are used within the optimizer 126. The optimizer 126 includes an optimization algorithm 127 that uses the predictive models 124 to generate a design model 136 in a manner that optimizes the characteristics of the predictive models 124 for a given set of input parameters 101. The optimization algorithm 127 may include a linear programming algorithm, a quadratic linear programming algorithm or an integer/mixed-integer programming algorithm. The input parameters 101 may represent any type of data typically used in TCAD simulations, SPICE simulations, wafer/product level measurements, and/or power electronic lab results. In some examples, the input parameters 101 may include TCAD simulation parameters such as doping profile, thickness of semiconductor and dielectric regions, etch depth, and/or ion implant energy and dose. In some examples, the input parameters 101 may include SPICE simulation parameters such as circuit voltage, operating current, switching frequency, and/or value and architecture of passive filters like L-R-C elements. In some examples, the input parameters 101 may include wafer/product parameters such as mask design features, size and aspect ratio of various device regions, and/or circuit inter-connections. In some examples, the input parameters 101 may include power electronics lab parameters, which may be the same or similar to the SPICE parameters but obtained from actual lab measurements/settings rather than SPICE simulations.

For example, if the predictive models 124 include four predictive models that predicts breakdown voltage, voltage threshold, specific on-resistance, and efficiency, the optimizer 126 may generate a design model 136 in which the breakdown voltage, voltage threshold, specific on-resistance, and efficiency achieve certain thresholds (e.g., maximized, minimized, exceed a threshold level, below a threshold level). In some examples, the optimizer 126 may define constraints 128, goals 130, logic 132, and weights 134. The constraints 128 may provide limits on values for certain parameters or other types of constraints typically specified in an optimizer. The goals 130 may refer to performance targets such as whether to use a minimum or maximum, threshold levels, and/or binary constraints. The logic 132 may specify penalties, how to implement the goals 130 and/or logic 132, and/or whether to implement or disregard one or more constraints 128, etc. The weights 134 may include weight values that are applied to the input parameters 101. For example, the weights 134 may adjust the values of the input parameters 101. In some examples, a designer may provide the constraints 128, the goals 130, the logic 132, and/or the weights 134, which is highly dependent on the underlying use case. As such, the optimizer 126 may compute the design model 136 in a manner that meets the constraints 128 and/or goals 130 while achieving the characteristics of the predictive models 124.

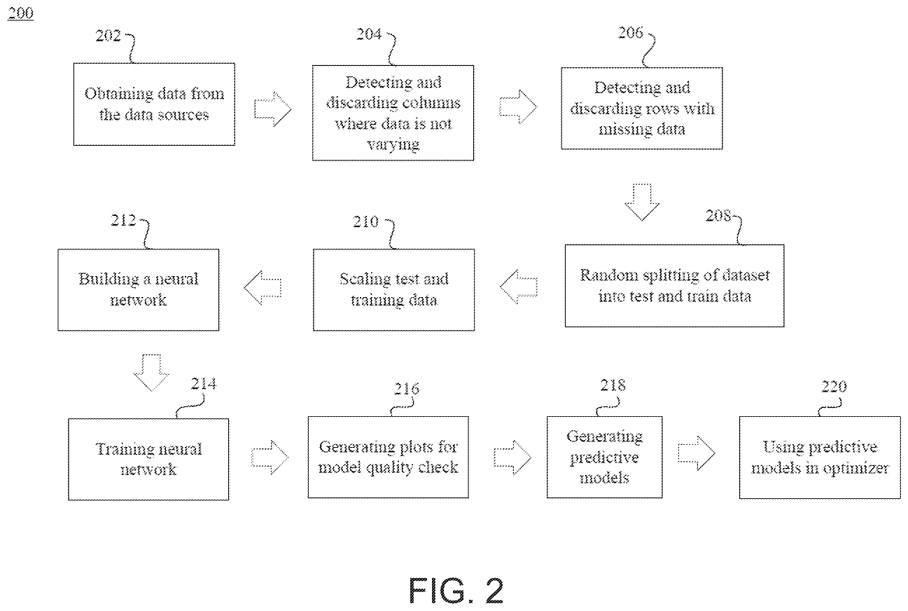

FIG. 2 illustrates a flowchart 200 depicting example operations using the semiconductor design system 100 of FIGS. 1A through 1F according to an aspect. Although the flowchart 200 is described with reference to the semiconductor design system 100 of FIGS. 1A through 1F, the flowchart 200 may be applicable to any of the embodiments herein. Although the flowchart 200 of FIG. 2 illustrates the operations in sequential order, it will be appreciated that this is merely an example, and that additional or alternative operations may be included. Further, operations of FIG. 2 and related operations may be executed in a different order than that shown, or in a parallel or overlapping fashion.

Operation 202 includes obtaining data from the data sources 102. In some examples, the data obtained from the data sources 102 are in the form of tables, where the data is tabular data. In some examples, the data includes TCAD simulations. In some examples, the data includes TCAD simulations, SPICE simulations, power electronics lab results, and/or wafer/product level measurements.

Operation 204 includes detecting and discarding columns where the data is not varying. For example, the data filter 108 is configured to discard (e.g., remove) data from a column where the data is not varying within the column. Non-varying data within a column may indicate that the data is not significant or interesting. Operation 206 includes detecting and discarding rows with missing data. For example, the data filter 108 is configured to discard (e.g., remove) data from a row where there is missing data from that row. Missing data within a particular row may indicate the existence of a convergence issue.

Operation 208 includes random splitting of dataset 109 into training data 116 and test data 118. For example, the data identifier 110 is configured to receive the dataset 109 may randomly split the dataset 109 into training data 116 that is used to train the neural network 114 and test data 118 that is used to test the neural network 114. Operation 210 includes scaling the training data 116 and the test data 118. For example, the data from the multiple data sources 102 may include data with various time and space scales, and the trainer module 104 may scale the training data 116 and the test data 118 so that the scales are relatively uniform.

Operation 212 includes building a neural network 114. For example, the neural network builder 112 may receive user input for a number of configurable parameters such as the number of hidden layers 146, the number of neurons 131 in each layer 143, the type of activation function, etc. In some examples, the user may use the computing device 152 to identify the number of hidden layers 146, the number of neurons 131 in each layer 143, and the type of activation function. In some examples, the user may specify the number or type of predictive models 124 to be generated during the training process.

Operation 214 includes training the neural network 114. For example, the trainer module 104 may train the neural network 114 with the training data 116. In some examples, the user may provide a number of configurable training parameters such as the number of epochs, the learning rate, and/or batch size, etc.

Operation 216 includes generating plots for model quality check. In some examples, the trainer module 104 is configured to generate a training error graph 117 that depicts the training error (e.g., root-mean-square-error (RMSE)) In some examples, the training error graph 117 depicts the RMSE against the number of epochs and/or learning rates. In some examples, the trainer module 104 is configured to generate one or more summary reports, which may include details about the model architecture. In some examples, the trainer module 104 generates plan English statements about each layer of the neural network 114.

Operation 218 includes generating predictive models 124. For example, the training of the neural network 114 generates one or more predictive models 124. Each predictive model 124 may predict to a separate characteristic. In one example, the characteristic is breakdown voltage of a transistor. However, the characteristic that is predicted by a predictive model 124 may encompass a wide variety of characteristics such as on-resistance, threshold voltage, efficiency (e.g., overall efficiency, individual efficiency of a particular stage or component).

Operation 220 includes using the predictive models 124 in the optimizer 126. The optimizer 126 includes an optimization algorithm 127 that uses the predictive models 124 to generate a design model 136 in a manner that optimizes the characteristics of the predictive models 124 for a given set of input parameters 101. For example, if the predictive models 124 include four predictive models that predicts breakdown voltage, voltage threshold, specific on-resistance, and efficiency, the optimizer 126 may generate a design model 136 in which the breakdown voltage, voltage threshold, specific on-resistance, and efficiency achieve certain thresholds (e.g., maximized, minimized, exceed a threshold level, below a threshold level). As such, the optimizer 126 may compute the design model 136 in a manner that meets the constraints 128 and/or goals 130 while maximizing or minimizing the characteristics of the predictive models 124.

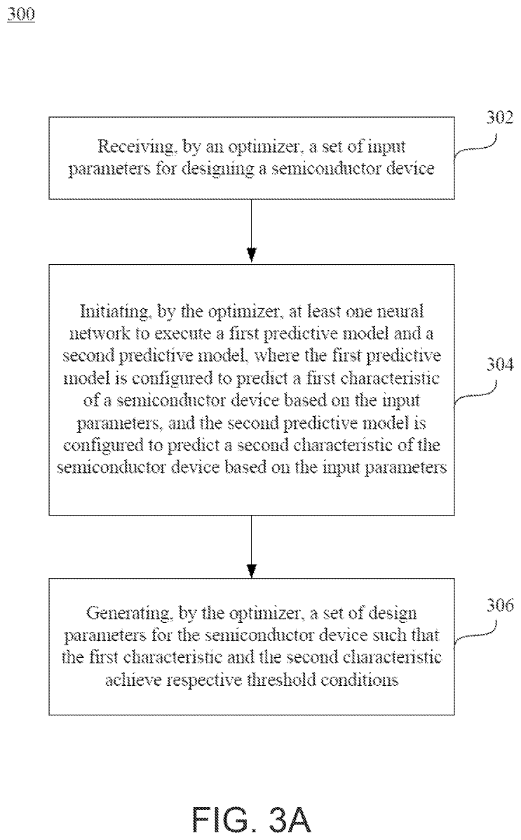

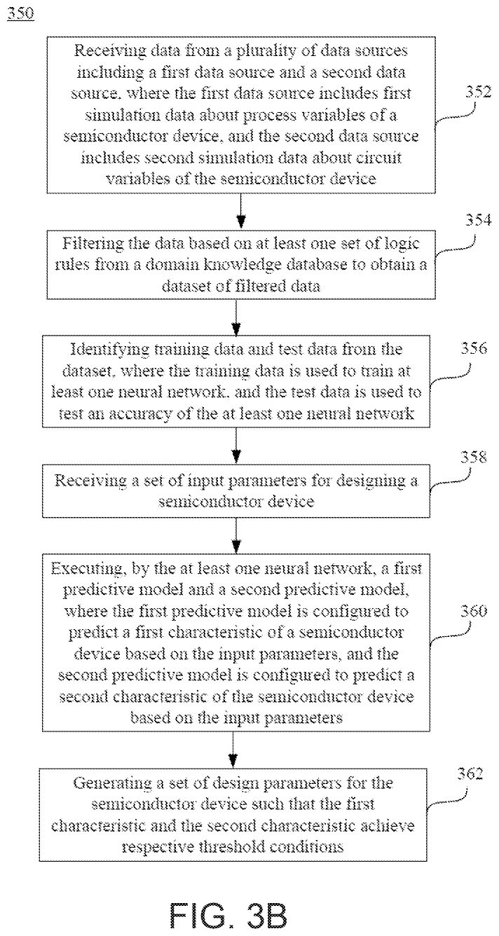

FIG. 3A illustrates a flowchart 300 depicting example operations using the semiconductor design system 100 of FIGS. 1A through 1F according to an aspect. Although the flowchart 300 is described with reference to the semiconductor design system 100 of FIGS. 1A through 1F, the flowchart 300 of FIG. 3A may be applicable to any of the embodiments herein. Although the flowchart 300 of FIG. 3A illustrates the operations in sequential order, it will be appreciated that this is merely an example, and that additional or alternative operations may be included. Further, operations of FIG. 3A and related operations may be executed in a different order than that shown, or in a parallel or overlapping fashion.

Operation 302 includes receiving, by an optimizer 126, a set of input parameters 101 for designing a semiconductor device. Operation 304 includes initiating, by the optimizer 126, at least one neural network 114 to execute a first predictive model 124-1 and a second predictive model 124-2, where the first predictive model 124-1 is configured to predict a first characteristic of a semiconductor device based on the input parameters 101, and the second predictive model 124-2 is configured to predict a second characteristic of the semiconductor device based on the input parameters 101. Operation 306 includes generating, by the optimizer 126, a set of design parameters for the semiconductor device such that the first characteristic and the second characteristic achieve respective threshold conditions.

FIG. 3B illustrates a flowchart 350 depicting example operations using the semiconductor design system 100 of FIGS. 1A through 1F according to an aspect. Although the flowchart 350 is described with reference to the semiconductor design system 100 of FIGS. 1A through 1F, the flowchart 350 of FIG. 3B may be applicable to any of the embodiments herein. Although the flowchart 350 of FIG. 3B illustrates the operations in sequential order, it will be appreciated that this is merely an example, and that additional or alternative operations may be included. Further, operations of FIG. 3B and related operations may be executed in a different order than that shown, or in a parallel or overlapping fashion.

Operation 352 includes receiving data from a plurality of data sources 102 including a first data source 102-1 and a second data source 102-2, where the first data source 102-1 includes first simulation data about process variables of a semiconductor device, and the second data source 102-2 includes second simulation data about circuit variables of the semiconductor device.

Operation 354 includes filtering the data based on at least one set of logic rules 162 from a domain knowledge database 160 to obtain a dataset 109 of filtered data. Operation 356 includes identifying training data 116 and test data 118 from the dataset 109, where the training data 116 is used to train at least one neural network 114, and the test data 118 is used to test an accuracy of the neural network 114. Operation 358 includes receiving a set of input parameters 101 for designing a semiconductor device.

Operation 360 includes executing, by the neural network 114, a first predictive model 124-1 and a second predictive model 124-2, where the first predictive model 124-1 is configured to predict a first characteristic of a semiconductor device based on the input parameters 101, and the second predictive model 124-2 is configured to predict a second characteristic of the semiconductor device based on the input parameters 101. Operation 362 includes generating a set of design parameters for a design model 136 of the semiconductor device such that the first characteristic and the second characteristic achieve respective threshold conditions.

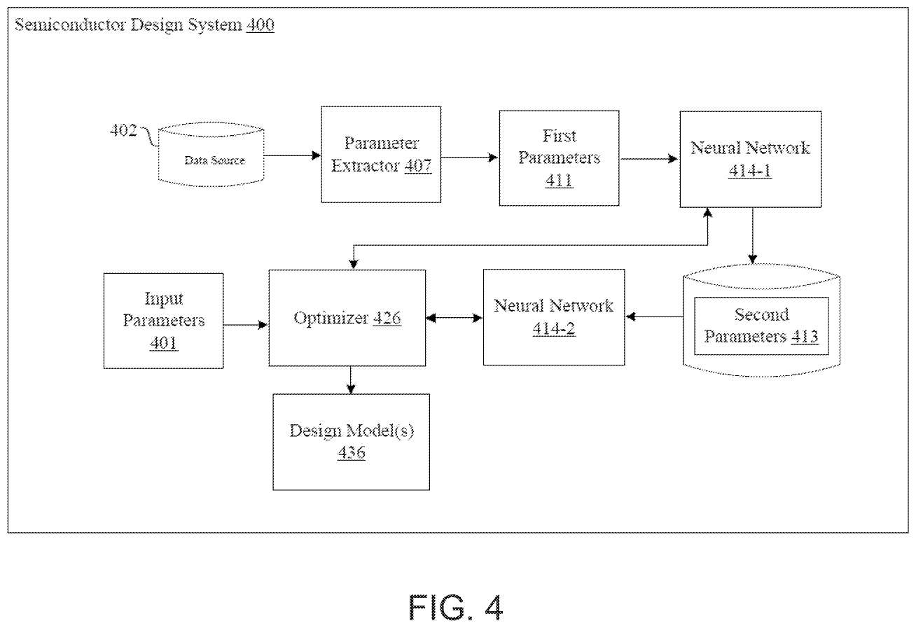

FIG. 4 illustrates a semiconductor design system 400 according to another aspect. The semiconductor design system 400 may be an example of the semiconductor design system 100 of FIGS. 1A through 1F and may include any of the details of those figures. The semiconductor design system 400 may be similar to the semiconductor design system 100 of FIGS. 1A through 1F except that the semiconductor design system 400 uses two neural networks, e.g., a first neural network 414-1, and a second neural network 414-2. First parameters 411 are used to train the first neural network 414-1, and second parameters 413 are used to separately train the second neural network 414-2. In some examples, the first parameters 411 have a lower level of abstraction than the second parameters 413. In some examples, the first parameters 411 connect process variables to electrical characteristics of the device. In some examples, the first parameters 411 include TCAD simulation parameters. In some examples, the second parameters 413 are used to connect TCAD process variables to system performance parameters. In some examples, the second parameters 413 include SPICE simulation parameters. As further explained below, the use of the first neural network 414-1 and the second neural network 414-2 can cause the amount of training data (and the amount of time to generate training data) to be reduced.

As indicated above, TCAD simulations require the use of solving partial differential equations on a finite difference grid and may be considered relatively computationally expensive. However, a TCAD simulation is considered powerful in the sense that a TCAD simulation can capture results across the process and the device, where it can predict how a process change will change the structure, and how the changed structure will change the electrical performance and response. As such, a TCAD simulation may provide a physical connection between the fabrication process and the electrical characteristics of the device. A SPICE simulator includes an equation-based model that represents device performance based on a set of complex equations. However, unlike a TCAD simulation (which solves partial differential equations), a SPICE simulation performs function calculations which are relatively faster (e.g., significantly faster) than a TCAD simulation. The SPICE models are dependent upon a set of input parameters (e.g., coefficients), and there may be tens or hundreds of these parameters in a simulation. Conventionally, it is not entirely straightforward how these parameters will connect to a process change. Typically, once there is a process change, a TCAD simulation is executed, and then a SPICE model is created, and a number of simulations is executed on the SPICE model. If there is another process change, a TCAD simulation is executed, and then another SPICE model is created, and a number of simulations is executed on the SPICE model. These TCAD simulations and SPICE simulations may be used to train a neural network (e.g., the neural network 114 of FIGS. 1A through 1F).

However, the complexity of the problem solved by the neural network may determine the amount of training data needed to train the neural network. If the complexity of the problem is relatively large, the amount of training data may be relatively large as well. However, by using the first neural network 114-1 and the second neural network 114-2 in the manner explained below, the amount of training data required to train the neural networks may be reduced.

The semiconductor design system 400 may include a data source 402. However, the semiconductor design system 400 (similar to the semiconductor design system 100 of FIGS. 1A through 1F) may operate in conjunction with a number of data sources 402. In some examples, the data source 402 includes TCAD simulations. The semiconductor design system 400 includes a parameter extractor 407 configured to extract the first parameters 411 (e.g., TCAD simulation parameters) from the TCAD simulations. The first neural network 414-1 is trained with the first parameters 411 to predict second parameters 413 (e.g., SPICE parameters). For example, for a given set of process conditions (as provided by the first parameters 411), the first neural network 414-1 (after being trained) can predict the second parameters 413 (e.g., the SPICE model parameters or the SPICE simulations). Then, the neural network 414-2 can be trained using only the second parameters 413 (e.g., the SPICE simulations), where the neural network 412-2 can be used to predict system level characteristics such as efficiency. In this matter, additional TCAD simulations do not have to be executed because the first neural network 414-1 can predict what the SPICE model parameters will be for a given set of process conditions, which can decrease the amount of time to generate training data and/or the amount of training data that is required to train the first neural network 414-1 and the second neural network 414-2.

Accordingly, the first neural network 414-1 is used for the prediction of the second parameters 413 (e.g., SPICE simulations) for a given set of TCAD simulations, and the second neural network 414-2 is used for the prediction of system performance parameters. The semiconductor design system 400 includes an optimizer 426 configured to operate in conjunction with the neural network 414-2 to generate one or more design models 436 in the same manner as previously discussed with reference to FIGS. 1A through 1F.

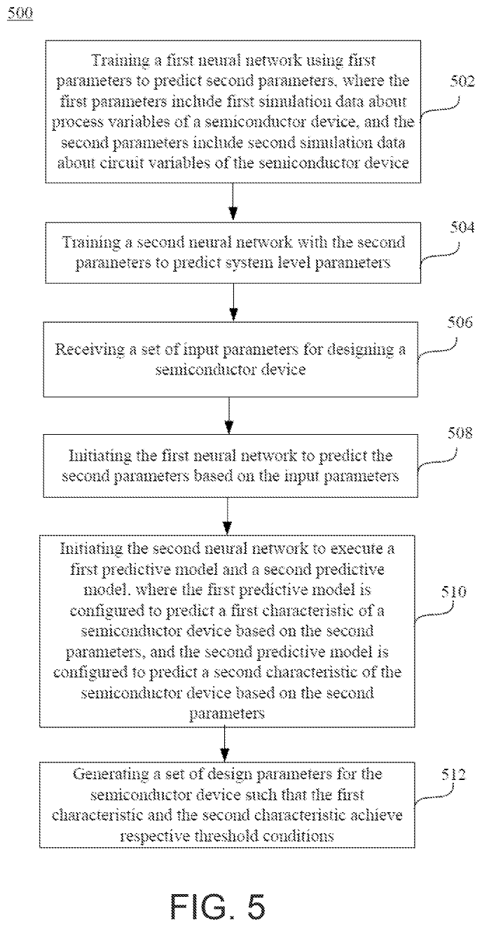

FIG. 5 illustrates a flowchart 500 depicting example operations using the semiconductor design system 400 of FIG. 4 according to an aspect. Although the flowchart 500 is described with reference to the semiconductor design system 400 of FIG. 4, the flowchart 500 may be applicable to any of the embodiments herein. Although the flowchart 500 of FIG. 5 illustrates the operations in sequential order, it will be appreciated that this is merely an example, and that additional or alternative operations may be included. Further, operations of FIG. 5 and related operations may be executed in a different order than that shown, or in a parallel or overlapping fashion.

Operation 502 includes training a first neural network 414-1 using first parameters 411 to predict second parameters 413, where the first parameters 411 include first simulation data about process variables of a semiconductor device, and the second parameters 413 include second simulation data about circuit variables of the semiconductor device.

Operation 504 includes training a second neural network 414-2 with the second parameters 413 to predict system level parameters. Operation 506 includes receiving a set of input parameters 401 for designing a semiconductor device. Operation 508 includes initiating the first neural network 414-1 to predict the second parameters 413 based on the input parameters 401.

Operation 510 includes initiating the second neural network 414-2 to execute a first predictive model (e.g., first predictive model 124-1 of FIG. 1D) and a second predictive model (e.g., the first predictive model 124-2 of FIG. 1D), where the first predictive model is configured to predict a first characteristic of a semiconductor device based on the second parameters 413, and the second predictive model is configured to predict a second characteristic of the semiconductor device based on the second parameters 413. Operation 512 includes generating a set of design parameters for the semiconductor device such that the first characteristic and the second characteristic achieve respective threshold conditions.

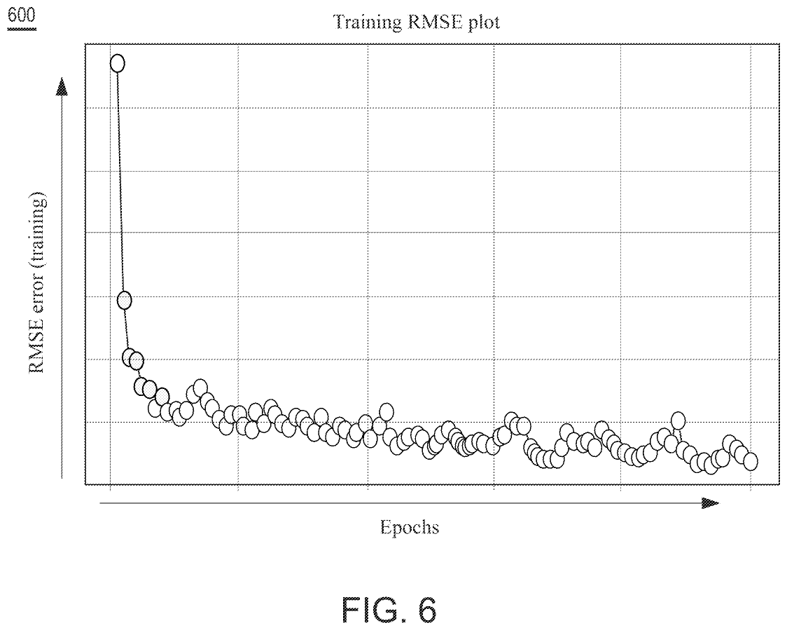

FIG. 6 illustrates a representative plot 600 of training error versus epochs. In some examples, the training error includes RMSE. As shown in FIG. 6, the RMSE is plotted against the number of epochs. However, in some examples, the RMSE may be plotted against learning rates. In some examples, the representative plot 600 may be provided by the trainer module 104 of FIG. 1A to a user so that the user can review the training errors against configurable training parameters.

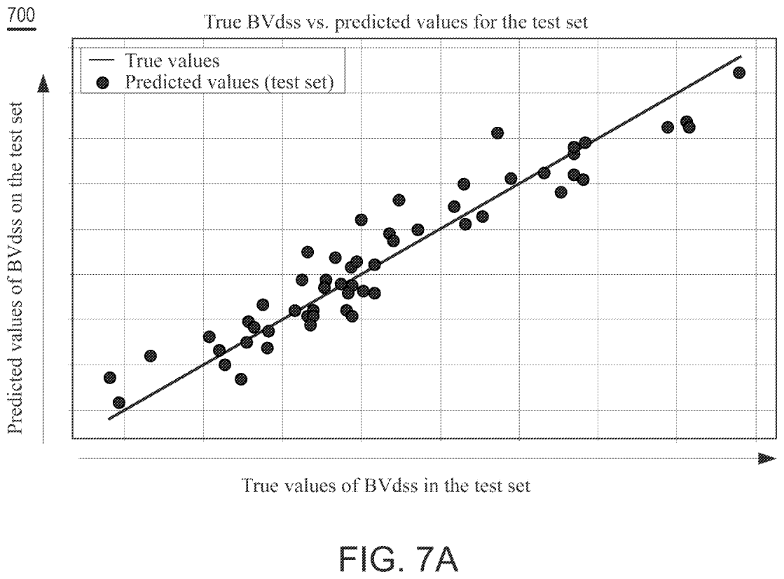

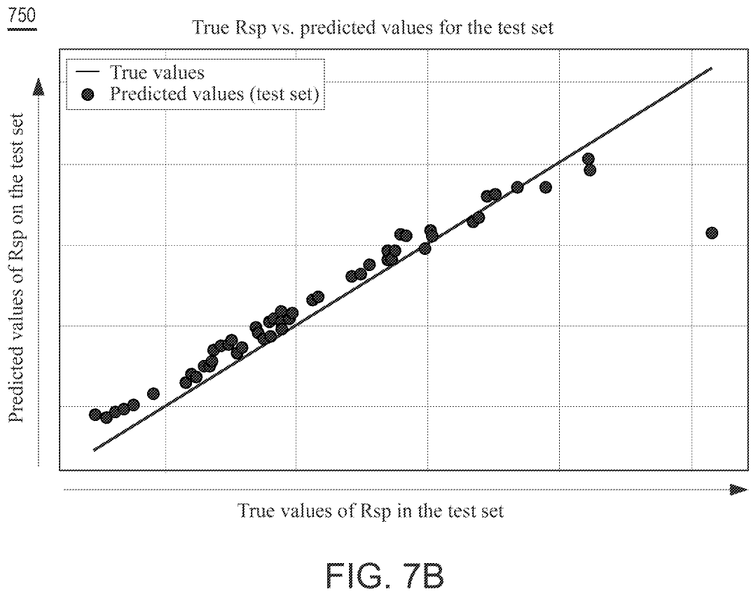

FIGS. 7A and 7B illustrate breakdown voltage (BVDss) and specific on-resistance (Rsp), respectively, for a high-voltage FET system using the semiconductor design systems discussed herein. For example, FIG. 7A illustrates a graph 700 depicting predicted BVdss values for the test set against the true BVDss values, and FIG. 7B illustrates a graph 750 depicting predicted Rsp values for the test set against the true Rsp values. In some examples, the neural network predictions are within an acceptable threshold (e.g., within 5%) of the TCAD simulations, but the neural network predictions are significantly faster. In some examples, in the case of one thousand input cases (each with fifteen process variables), the neural network can calculate BVdss in seconds (e.g., less than two seconds). In contrast, a similar number of TCAD simulations would have taken two thousands hours cumulatively (or at least three days if thirty days if thirty licenses were used concurrently).

The embodiments discussed above may include a densely-connected, user-configurable, parametrically-tunable, deep neural network (DNN) architecture, which can generate accurate mapping between various types of numerical data streams, as generated by semiconductor design and optimization processes. Also, the embodiments provide a predictive functional interface, which can be used by any high-level optimization software. By using DNN, the systems discussed herein balance the trade-off of accuracy and speed of predictive mapping. Traditionally, semiconductor engineers build linear/2nd-degree predictive models with only tens of parameters. However, the embodiments discussed herein may enable modeling with thousands of parameters, complex enough for capturing highly nonlinear interaction, but fast enough for prediction tasks (compared to TCAD or PSPICE runs) using any modern compute infrastructure.

In case of TCAD-driven optimization, the embodiment discussed herein may enable increase the speed of optimization (e.g., expensive TCAD run(s) may not be involved in the actual optimization process). In some examples, the DNN-based predictive function being faster (e.g., ˜1000× faster) than a single physics-based TCAD run. By largely replacing the actual TCAD runs in the semiconductor design optimization process, the embodiments discussed herein may enable higher stability and complex optimization goal/constraint settings, which are well-known limitations of current TCAD software products.

Furthermore, the embodiments discussed herein may provide a single, unified software interface which can be used by all kinds of engineering personnel such as device designer, apps engineers, integration engineers using TCAD, package development engineers using a different TCAD tool, designers looking for optimum die design parameters using PSPICE tools, and/or integration and yield engineers looking for patterns and predictive power from the large amounts of datasets generated by wafer experiments. In addition, the embodiments discussed herein may provide additional domain-specific utility methods such as logic-based filtering, data cleaning, scaling, and missing data imputation (e.g., beneficial for proper pattern matching), and useful for incorporating domain expertise of engineers. Also, the embodiments discussed herein may provide model saving and updating methods for continuous improvement.

Often, a practical optimization involves complicated sets of mutually interacting constraints. In the traditional optimization platform, some limitations on imposing arbitrary constraints during an optimization run are encountered. This is not unexpected since the satisfaction of constraints depend on the penalty imposed on their violation, and that process often destabilizes the TCAD design space. It stems from the very nature of the finite-element solver dynamics and the numerical algorithms. This may often lead to slow or failed optimization runs where many points in the design space will not have a finite value (due to non-convergence of the underlying TCAD simulation). The DNN-based approach discussed above may solve this problem efficiently. Essentially, once a DNN model is trained properly, the DNN model may provide a finite, well-behaved numerical output for an input setting, which falls within the distribution of the dataset used in the training process.

In the specification and/or figures, typical embodiments have been disclosed. The present disclosure is not limited to such exemplary embodiments. The use of the term “and/or” includes any and all combinations of one or more of the associated listed items. The figures are schematic representations and so are not necessarily drawn to scale. Unless otherwise noted, specific terms have been used in a generic and descriptive sense and not for purposes of limitation.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described.

What is claimed is:

1. A semiconductor design system comprising:
at least one neural network including a first predictive model and a second predictive model, the first predictive model configured to predict a first characteristic of a semiconductor device, the second predictive model configured to predict a second characteristic of the semiconductor device; and
an optimizer configured to use the neural network to generate a design model based on a set of input parameters, the design model including a set of design parameters for the semiconductor device such that the first characteristic and the second characteristic achieve respective threshold conditions.

2. The semiconductor design system of claim 1, wherein each of the first characteristic and the second characteristic includes breakdown voltage, specific on-resistance, voltage threshold, or efficiency.

3. The semiconductor design system of claim 1, wherein the set of design parameters includes at least one of process parameters, circuit parameters, or device parameters.

4. The semiconductor design system of claim 1, wherein the design model includes a visual object that graphically represents a fabrication process for creating the semiconductor device.

5. The semiconductor design system of claim 1, further comprising:
a plurality of data sources including a first data source and a second data source, the first data source including first simulation data about process variables of the semiconductor device, the second data source including second simulation data about circuit variables of the semiconductor device; and
a trainer module configured to train the neural network based on data received from the first data source and the second data source.

6. The semiconductor design system of claim 5, wherein the trainer module includes:
a data filter configured to filter the data from the first data source and the second data source to obtain a dataset of filtered data; and
a data identifier configured to identify training data and test data from the dataset, wherein the training data is configured to be used to train the neural network, and the test data is configured to be used to test an accuracy of the neural network.

7. The semiconductor design system of claim 6, wherein the trainer module includes:
a testing engine configured to test the accuracy of the neural network based on the test data, the testing engine configured to generate at least one quality check graph that depict predicted values for the first characteristic in view of ground truth values for the first characteristic.

8. The semiconductor design system of claim 6, wherein the data filter includes:
a data type module configured to identify that tabular data from the plurality of data sources is associated with the first data source;
a logic rule selector configured to select a set of logic rules from a domain knowledge database that corresponds to the first data source; and
a logic rule applier configured to apply the set of logic rules to the tabular data to remove one or more missing values within a row or column or remove one or more values that are not varying within a row or column.

9. The semiconductor design system of claim 1, wherein the at least one neural network includes a first neural network and a second neural network, wherein the first neural network is configured to be trained using first parameters to predict second parameters, wherein the second neural network is configured to be trained using second parameters to predict system level parameters for the semiconductor device.

10. The semiconductor design system of claim 9, wherein the first parameters include first simulation data about process variables of the semiconductor device, and the second parameters include second simulation data about circuit variables of the semiconductor device.

11. A non-transitory computer-readable medium storing executable instructions that when executed by at least one processor is configured to cause the at least one processor to:
receive, by an optimizer, a set of input parameters for designing a semiconductor device;
initiate, by the optimizer, at least one neural network to execute a first predictive model and a second predictive model, the first predictive model configured to predict a first characteristic of a semiconductor device based on the input parameters, the second predictive model configured to predict a second characteristic of the semiconductor device based on the input parameters; and
generate, by the optimizer, a set of design parameters for the semiconductor device such that the first characteristic and the second characteristic achieve respective threshold conditions.

12. The non-transitory computer-readable medium of claim 11, wherein the executable instructions include instructions that cause the at least one processor to:
initiate, by the optimizer, the at least one neural network to execute a third predictive model and a fourth predictive model, the third predictive model configured to predict a third characteristic of the semiconductor device based on the input parameters, the fourth predictive model configured to predict a fourth characteristic of the semiconductor device based on the input parameters,
wherein the set of design parameters are generated such that each of the first characteristic, the second characteristic, the third characteristic, and the fourth characteristic is maximized or minimized.

13. The non-transitory computer-readable medium of claim 11, wherein the executable instructions include instructions that cause the at least one processor to:
receive data from a plurality of data sources;
filter the data based on a domain knowledge database to obtain a dataset of filtered data; and
randomly split the dataset into training data and test data, wherein the training data is configured to be used to train the neural network and the test data is used to test the neural network.

14. The non-transitory computer-readable medium of claim 13, wherein the plurality of data sources include a first data source that includes technology computer-aided design (TCAD) simulation variables, a second data source that includes simulation program with integrated circuit emphasis (SPICE) simulation variables, a third data source that includes power electronics lab results, and a fourth data source that includes wafer level measurements.

15. The non-transitory computer-readable medium of claim 13, wherein the executable instructions to filter the data include instructions that cause the at least one processor to:
identify that data is associated with a first data source among the plurality of data sources;
select a set of logic rules from the domain knowledge database that corresponds to the first data source; and
apply the set of logic rules to the data to filter the data.

16. The non-transitory computer-readable medium of claim 11, wherein the at least one neural network includes a first neural network and a second neural network, wherein the first neural network is configured to be trained using first parameters to predict second parameters, wherein the second neural network is configured to be trained using the second parameters to predict system level parameters for the semiconductor device, the first parameters including technology computer-aided design (TCAD) simulation variables, the second parameters including simulation program with integrated circuit emphasis (SPICE) simulation variables.

17. A method for semiconductor design system, the method comprising:
receiving data from a plurality of data sources including a first data source and a second data source, the first data source including first simulation data about process variables of a semiconductor device, the second data source including second simulation data about circuit variables of the semiconductor device;
filtering the data based on at least one set of logic rules from a domain knowledge database to obtain a dataset of filtered data;
identifying training data and test data from the dataset, the training data being used to train at least one neural network, the test data being used to test an accuracy of the at least one neural network;
receiving a set of input parameters for designing a semiconductor device;
executing, by the at least one neural network, a first predictive model and a second predictive model, the first predictive model configured to predict a first characteristic of a semiconductor device based on the input parameters, the second predictive model configured to predict a second characteristic of the semiconductor device based on the input parameters; and
generating a set of design parameters for a design model of the semiconductor device such that the first characteristic and the second characteristic achieve respective threshold conditions.

18. The method of claim 17, wherein the plurality of data sources include a third data source and a fourth data source, the third data source including power electronics lab results, the fourth data source including wafer level measurements.

19. The method of claim 17, wherein the filtering step includes:
identifying that first data is associated with the first data source;
selecting a first set of logic rules from the domain knowledge database that corresponds to the first data source;
applying the first set of logic rules to the first data;
identifying that second data is associated with the second data source;
selecting a second set of logic rules from the domain knowledge database that corresponds to the second data source; and
applying the second set of logic rules to the second data.

20. The method of claim 17, wherein the at least one neural network includes a first neural network and a second neural network, the method further comprising:
training the first neural network using technology computer-aided design (TCAD) simulations to predict simulation program with integrated circuit emphasis (SPICE) variables; and
training the second neural network with the SPICE variables to predict system level parameters.
